(19) United States
(12) Patent Application Publication
(10) Pub. No.: US 2023/0143300 A1
(43) Pub. Date: May 11, 2023

(54) DETECTION SYSTEM AND DETECTION METHOD

(71) Applicant: Komatsu Ltd., Tokyo (JP)

(72) Inventors: Taro EGUCHI, Tokyo (JP); Koichi NAKAZAWA, Tokyo (JP); Takeshi KURIHARA, Tokyo (JP); Yoshiyuki SHITAYA, Tokyo (JP)

(21) Appl. No.: 17/910,900

(22) PCT Filed: Mar. 29, 2021
(86) PCT No.: PCT/JP2021/013230

§ 371 Date: Sep. 12, 2022

(30) Foreign Application Priority Data
Mar. 31, 2020 (JP) 2020-065033

(51) Int. Cl. G06V 20/52; G06V 40/10; H04N 5/77; G08B 21/02

(52) U.S. Cl. CPC G06V 20/52; G06V 40/10; H04N 5/77; G08B 21/02

(57) ABSTRACT

A detection system includes an acquisition unit configured to acquire captured data from an imaging device that captures an image of a site, and a dangerous act determination unit configured to determine whether a person who performs a dangerous act is present at the site based on the captured data.

### TECHNICAL FIELD

The present invention relates to a detection system and a detection method.

Priority is claimed on Japanese Patent Application No. 2020-065033, filed Mar. 31, 2020, the content of which is incorporated herein by reference.

### BACKGROUND ART

Patent Document 1 discloses a technique related to a peripheral monitoring system that detects a person in the vicinity of a work machine. According to the technique described in Patent Document 1, the peripheral monitoring system detects a surrounding obstacle.

### CITATION LIST

### Patent Document

### Patent Document 1

Japanese Unexamined Patent Application, First Publication No. 2016-035791

### SUMMARY OF INVENTION

### Technical Problem

For the safety of workers, it is important to avoid a dangerous act such as non-wearing of protective equipment such as a helmet and a safety vest and walking while operating a smartphone at the site in which a work machine operates. Therefore, the supervisor must always pay attention to whether the dangerous act has been performed at the site, which places a heavy burden on the supervisor.

An object of the present invention is to provide a detection system and a detection method capable of easily detecting the presence or absence of a dangerous act.

### Solution to Problem

According to a first aspect, a detection system includes an acquisition unit configured to acquire captured data from an imaging device that captures an image of a site, and a dangerous act determination unit configured to determine whether a person who performs a dangerous act is present at the site based on the captured data.

### Advantageous Effects of Invention

According to the above aspect, the presence or absence of a dangerous act can be easily detected by using the detection system.

### BRIEF DESCRIPTION OF DRAWINGS

FIG. 1 is a schematic diagram showing a configuration of a work machine according to a first embodiment.

FIG. 2 is a diagram showing imaging ranges of a plurality of cameras provided in the work machine according to the first embodiment.

FIG. 3 is a diagram showing an internal configuration of a cab according to the first embodiment.

FIG. 4 is a schematic block diagram showing a configuration of a control device according to the first embodiment.

FIG. 5 is a table showing an example of information stored in the dangerous act dictionary data according to the first embodiment.

FIG. 6 is a flowchart showing an operation of the control device according to the first embodiment.

FIG. 7 is a diagram showing an example of a captured image by the camera according to the first embodiment.

### DESCRIPTION OF EMBODIMENTS

### First Embodiment

Hereinafter, an embodiment of the present invention is described with reference to the drawings.

A detection system according to a first embodiment is realized by a work machine 100 arranged at the site.

<<Configuration of Work Machine 100>>

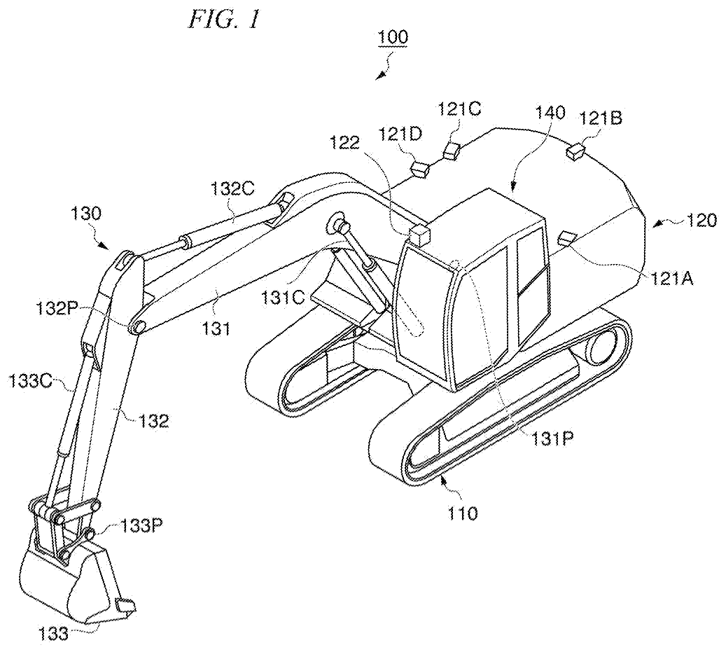

FIG. 1 is a schematic diagram showing a configuration of a work machine 100 according to a first embodiment.

The work machine 100 operates at a construction site to construct a construction target such as earth. The work machine 100 according to the first embodiment is, for example, a hydraulic excavator. The work machine 100 includes an undercarriage 110, a swing body 120, work equipment 130, and a cab 140. Incidentally, the work machine 100 may be a work machine for a mine such as a mining excavator that operates in a mine with the site as a mine.

The undercarriage 110 movably supports the work machine 100. The undercarriage 110 is, for example, a pair of right and left endless tracks.

The swing body 120 is supported by the undercarriage 110 to be swingable around a swing center.

The work equipment 130 is driven by hydraulic pressure. The work equipment 130 is supported by a front portion of the swing body 120 to be capable of driving in an up to down direction. The cab 140 is a space in which an operator gets in to operate the work machine 100. The cab 140 is provided on a left front portion of the swing body 120.

Here, a portion of the swing body 120 to which the work equipment 130 is attached is referred to as a front portion. In addition, in the swing body 120, based on the front portion, a portion opposite to the front is referred to as a rear portion, a portion on a left side is referred to as a left portion, and a portion on a right side is referred to as a right portion.

<<Configuration of Swing Body 120>>

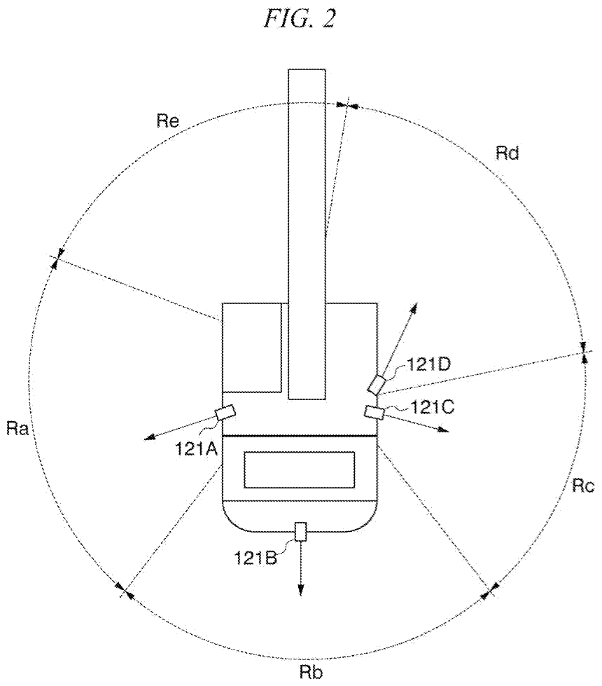

A plurality of cameras 121 that capture an image of the periphery of the work machine 100 and a speaker 122 that outputs voice to the outside of the work machine 100 are provided in the swing body 120. An exemplary example of the speaker 122 is a horn speaker. FIG. 2 is a diagram showing imaging ranges of the plurality of cameras 121 provided in the work machine 100 according to the first embodiment.

Specifically, the swing body 120 is provided with a left rear camera 121A that captures an image of a left rear region Ra of the periphery of the swing body 120, a rear camera 121B that captures an image of a rear region Rb of the periphery of the swing body 120, a right rear camera 121C that captures an image of a right rear region Rc of the periphery of the swing body 120, and a right front camera 121D that captures an image of a right front region Rd of the periphery of the swing body 120. Incidentally, the imaging ranges of the plurality of cameras 121 may partially overlap each other.

The imaging ranges of the plurality of cameras 121 cover a range of an entire periphery of the work machine 100 excluding a left front region Re that is visually recognized from the cab 140. Incidentally, the cameras 121 according to the first embodiment capture images of regions on left rear, rear, right rear, and right front sides of the swing body 120, but are not limited thereto in another embodiment. For example, the number of the cameras 121 and the imaging ranges according to another embodiment may differ from the example shown in FIGS. 1 and 2.

Incidentally, as shown by the rear range Rb in FIG. 2, the left rear camera 121A captures an image of a range of a left side region and a left rear region of the swing body 120, but may capture an image of one region thereof. Similarly, as shown by the right rear range Rc in FIG. 2, the right rear camera 121C captures an image of a range of a right side region and a right rear region of the swing body 120, but may capture an image of one region thereof. Similarly, as shown by the right front range Rd in FIG. 2, the right front camera 121D captures an image of a range of a right front region and the right side region of the swing body 120, but may capture an image of one region thereof. In addition, in another embodiment, the plurality of cameras 121 may be used so that the entire periphery of the work machine 100 is set as the imaging range. For example, the left front camera that captures the image of the left front range Re may be provided, and the entire periphery of the work machine 100 may be set as the imaging range.

<<Configuration of Work Equipment 130>>

The work equipment 130 includes a boom 131, an arm 132, a bucket 133, a boom cylinder 131C, an arm cylinder 132C, and a bucket cylinder 133C.

A proximal end portion of the boom 131 is attached to the swing body 120 via a boom pin 131P.

The arm 132 connects the boom 131 and the bucket 133. A proximal end portion of the arm 132 is attached to a distal end portion of the boom 131 via an arm pin 132P. The bucket 133 includes blades that excavate earth or the like, and an accommodating portion that accommodates the excavated earth. A proximal end portion of the bucket 133 is attached to a distal end portion of the arm 132 via a bucket pin 133P.

The boom cylinder 131C is a hydraulic cylinder that operates the boom 131. A proximal end portion of the boom cylinder 131C is attached to the swing body 120. A distal end portion of the boom cylinder 131C is attached to the boom 131.

The arm cylinder 132C is a hydraulic cylinder that drives the arm 132. A proximal end portion of the arm cylinder 132C is attached to the boom 131. A distal end portion of the arm cylinder 132C is attached to the arm 132.

The bucket cylinder 133C is a hydraulic cylinder that drives the bucket 133. A proximal end portion of the bucket cylinder 133C is attached to the arm 132. A distal end portion of the bucket cylinder 133C is attached to a link member connected to the bucket 133.

<<Configuration of Cab 140>>

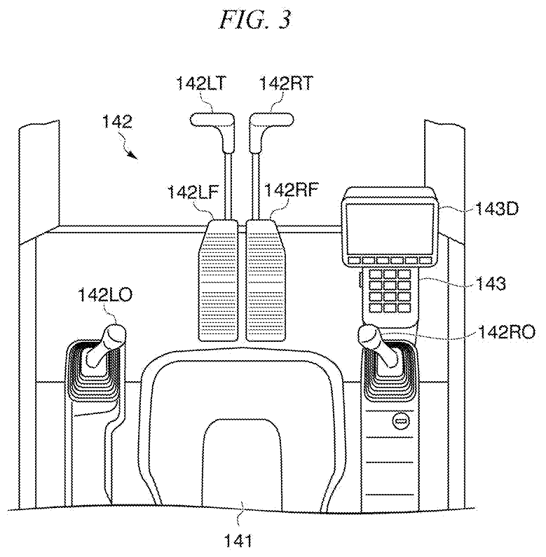

FIG. 3 is a diagram showing an internal configuration of the cab 140 according to the first embodiment.

A driver seat 141, an operation device 142, and a control device 143 are provided in the cab 140.

The operation device 142 is a device to drive the undercarriage 110, the swing body 120, and the work equipment 130 by a manual operation of the operator. The operation device 142 includes a left operation lever 142LO, a right operation lever 142RO, a left foot pedal 142LF, a right foot pedal 142RF, a left traveling lever 142LT, and a right traveling lever 142RT.

The left operation lever 142LO is provided on a left side of the driver seat 141. The right operation lever 142RO is provided on a right side of the driver seat 141.

The left operation lever 142LO is an operation mechanism that causes the swing body 120 to perform a swing operation and causes the arm 132 to perform a pulling or pushing operation. Specifically, when the operator of the work machine 100 tilts the left operation lever 142LO forward, the arm 132 is pushed. In addition, when the operator of the work machine 100 tilts the left operation lever 142LO backward, the arm 132 is pulled. In addition, when the operator of the work machine 100 tilts the left operation lever 142LO in a right direction, the swing body 120 swings rightward. In addition, when the operator of the work machine 100 tilts the left operation lever 142LO in a left direction, the swing body 120 swings leftward. Incidentally, in another embodiment, when the left operation lever 142LO is tilted in a front to back direction, the swing body 120 may swing rightward or swing leftward, and when the left operation lever 142LO is tilted in a right to left direction, the arm 132 may perform a pulling operation or a pushing operation.

The right operation lever 142RO is an operation mechanism that causes the bucket 133 to perform an excavating or dumping operation and causes the boom 131 to perform a rising or lowering operation. Specifically, when the operator of the work machine 100 tilts the right operation lever 142RO forward, a lowering operation of the boom 131 is executed. In addition, when the operator of the work machine 100 tilts the right operation lever 142RO backward, a rising operation of the boom 131 is executed. In addition, when the operator of the work machine 100 tilts the right operation lever 142RO in the right direction, a dumping operation of the bucket 133 is performed. In addition, when the operator of the work machine 100 tilts the right operation lever 142RO in the left direction, an excavating operation of the bucket 133 is performed. Incidentally, in another embodiment, when the right operation lever 142RO is tilted in the front to back direction, the bucket 133 may perform a dumping operation or an excavating operation, and when the right operation lever 142RO is tilted in the right to left direction, the boom 131 may perform a rising operation or a lowering operation.

The left foot pedal 142LF is arranged on a left side of a floor surface in front of the driver seat 141. The right foot pedal 142RF is arranged on a right side of the floor surface in front of the driver seat 141. The left traveling lever 142LT is pivotally supported by the left foot pedal 142LF and is configured such that the inclination of the left traveling lever 142LT and the pressing down of the left foot pedal 142LF are linked to each other. The right traveling lever 142RT is pivotally supported by the right foot pedal 142RF and is configured such that the inclination of the right traveling lever 142RT and the pressing down of the right foot pedal 142RF are linked to each other.

The left foot pedal 142LF and the left traveling lever 142LT correspond to rotational drive of a left crawler belt of the undercarriage 110. Specifically, when the operator of the work machine 100 tilts the left foot pedal 142LF or the left traveling lever 142LT forward, the left crawler belt rotates in a forward movement direction. In addition, when the operator of the work machine 100 tilts the left foot pedal 142LF or the left traveling lever 142LT backward, the left crawler belt rotates in a backward movement direction.

The right foot pedal 142RF and the right traveling lever 142RT correspond to rotational drive of a right crawler belt of the undercarriage 110. Specifically, when the operator of the work machine 100 tilts the right foot pedal 142RF or the right traveling lever 142RT forward, the right crawler belt rotates in the forward movement direction. In addition, when the operator of the work machine 100 tilts the right foot pedal 142RF or the right traveling lever 142RT backward, the right crawler belt rotates in the backward movement direction.

The control device 143 includes a display 143D that displays information related to a plurality of functions of the work machine 100. The control device 143 is one example of a display system. In addition, the display 143D is one example of a display unit. Input means of the control device 143 according to the first embodiment is a hard key. Incidentally, in another embodiment, a touch panel, a mouse, a keyboard, or the like may be used as the input means. In addition, the control device 143 according to the first embodiment is provided integrally with the display 143D, but in another embodiment, the display 143D may be provided separately from the control device 143. Incidentally, when the display 143D and the control device 143 are separately provided, the display 143D may be provided outside the cab 140. In this case, the display 143D may be a mobile display. In addition, when the work machine 100 is driven by remote operation, the display 143D may be provided in a remote operation room provided remotely from the work machine 100.

Incidentally, the control device 143 may be configured by a single computer, or the configuration of the control device 143 may be divided into a plurality of computers, such that the plurality of computers may cooperate with each other to function as a detection system. That is, the work machine 100 may include a plurality of computers that function as the control device 143. Incidentally, the above-mentioned one control device 143 is also one example of the detection system.

<<Configuration of Control Device 143>>

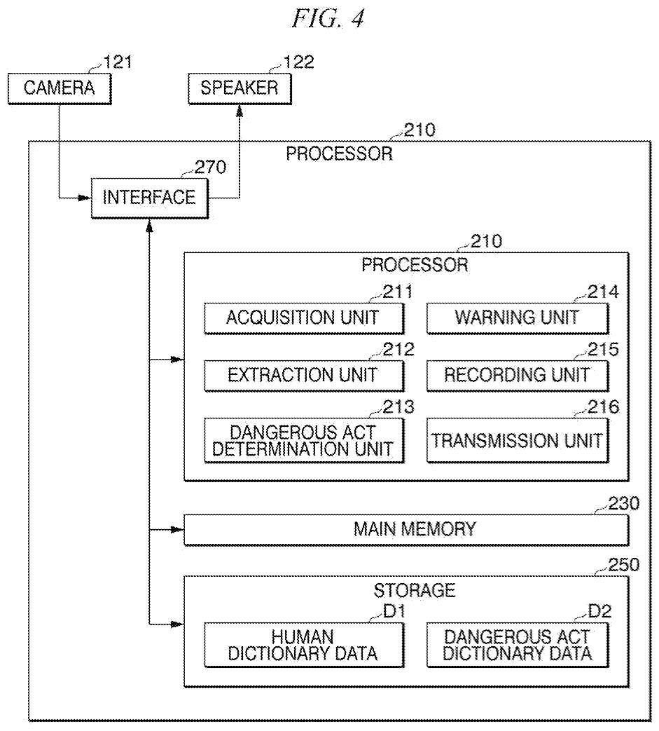

FIG. 4 is a schematic block diagram showing the configuration of the control device 143 according to the first embodiment.

The control device 143 is a computer including a processor 210, a main memory 230, a storage 250, and an interface 270.

The camera 121 and the speaker 122 are connected to the processor 210 via the interface 270.

Exemplary examples of the storage 250 include an optical disk, a magnetic disk, a magneto-optical disk, a semiconductor memory, or the like. The storage 250 may be an internal medium that is directly connected to a bus of the control device 143 or may be an external medium connected to the control device 143 via the interface 270 or a communication line. The storage 250 stores a program for realizing the monitoring of the periphery of the work machine 100. In addition, the storage 250 stores in advance a plurality of images including an icon for displaying on the display 143D.

The program may realize some of functions to be exhibited by the control device 143. For example, the program may exhibit functions in combination with another program that is already stored in the storage 250 or in combination with another program installed in another device. Incidentally, in another embodiment, the control device 143 may include a custom large scale integrated circuit (LSI) such as a programmable logic device (PLD) in addition to the above configuration or instead of the above configuration. Exemplary examples of the PLD include a programmable array logic (PAL), a generic array logic (GAL), a complex programmable logic device (CPLD), and a field programmable gate array (FPGA). In this case, some or all of the functions to be realized by the processor 210 may be realized by the integrated circuit.

In addition, the storage 250 stores a human dictionary data D1 for detecting a person and a dangerous act dictionary data D2 for detecting a dangerous act.

The human dictionary data D1 may be, for example, dictionary data of a feature amount extracted from each of a plurality of known images in which a person is reflected. Exemplary examples of the feature amount include histograms of oriented gradients (HOG), co-occurrence hog (CoHOG), or the like.

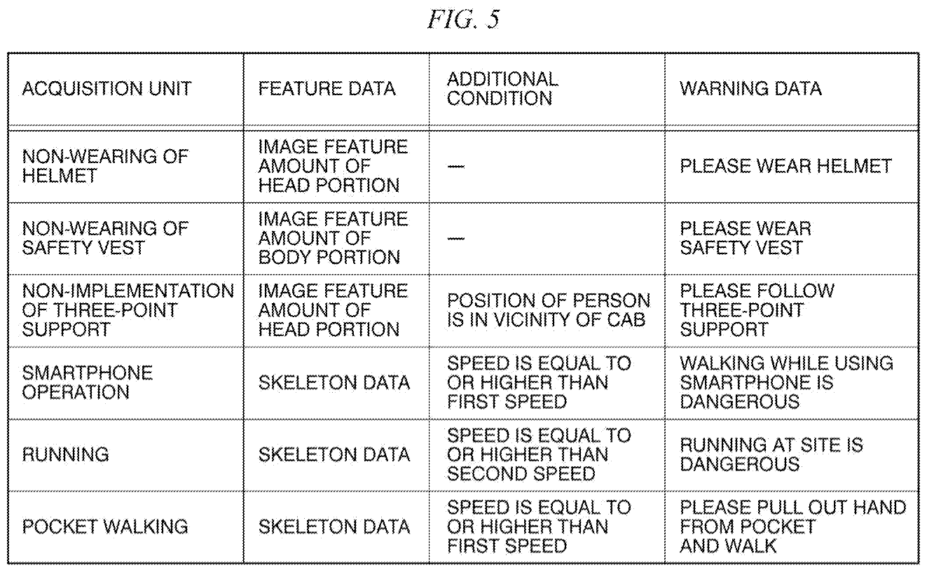

FIG. 5 is a table showing an example of information stored in the dangerous act dictionary data D2 according to the first embodiment.

The dangerous act dictionary data D2 stores feature data and warning data showing the feature of a person who performs a dangerous act for each type of dangerous acts to be detected. Exemplary examples of dangerous acts include non-wearing of a helmet, non-wearing of a safety vest, non-implementation of three-point support when rising and lowering the work machine 100, walking while operating a smartphone, running, walking while putting a hand in a pocket, or the like. Incidentally, the three-point support is to support the body by putting one foot on the footrest unit of the work machine 100 and grasping the handrest unit of the work machine 100 with both hands. The feature data of the person who performs the dangerous act may be represented by, for example, the feature amount of the image, or may be represented by the skeleton data showing the skeleton posture of the person. Incidentally, the safety vest is a work garment for safety such as preventing a contact accident by improving visibility, for example, a work garment to which a reflector is attached. In addition, instead of the safety vest, safety trousers with a reflector may be used.

In addition, the dangerous act dictionary data D2 may further store an additional condition in association with the feature data of the person who performs the dangerous act. When an additional condition is associated with the feature data, a feature matching the feature data is detected, and when the additional condition is satisfied, determination is made that the person who performs a dangerous act is present. When no additional condition is associated with the feature data, determination is made that the person who performs a dangerous act is present when a feature matching the feature data is detected.

For example, data showing features related to non-wearing of protective equipment such as a helmet, a safety vest, and safety trousers may be represented by the feature amount of the image of a person who does not wear the protective equipment. Incidentally, it should be noted that the feature amount may be represented not by the image of the whole body of a person but by the feature amount of the image of the place in which the protective equipment is worn. For example, the data showing the feature related to the non-wearing of the helmet may be represented by the feature amount of the image of the head portion of a person, and the data showing the feature related to the non-wearing of the safety vest may be represented by the feature amount of the image of the body portion of a person.

In addition, for example, the feature data related to the non-implementation of the three-point support may be represented by the feature amount of the image of the head portion of a person facing the outside of the work machine 100. The feature data is associated with an additional condition indicating that a person is in the vicinity of the cab 140 of the work machine 100. This is to detect the person jumping from the work machine 100.

In addition, for example, the data showing the feature related to walking while operating the smartphone may be represented by the skeleton data showing the posture of the person who operates the smartphone. That is, it may be represented by skeleton data representing a posture in which the head portion is lowered and the hand is positioned in front of the chest. The feature data is associated with an additional condition indicating that the person moves at a speed equal to or higher than a first speed.

In addition, for example, the data showing the feature related to running may be represented by the skeleton data showing the posture of the running person. The feature data is associated with an additional condition indicating that the person moves at a speed equal to or higher than a second speed. The second speed is faster than the first speed.

In addition, for example, the data showing the feature related to walking while putting the hand in the pocket may be represented by the skeleton data showing the posture of the person walking with the hand in the pocket. That is, it may be represented by skeleton data representing a posture in which the arm is fixed in the vicinity of the waist. The feature data is associated with an additional condition indicating that the person moves at a speed equal to or higher than a first speed.

Incidentally, in other embodiments, the data showing the feature related to walking while operating the smartphone, the data showing the feature related to running, and the data showing the feature related to walking while putting the hand in the pocket may not be represented by skeleton data. For example, when detecting walking while operating the smartphone, running, walking while putting the hand in the pocket, or the like by using a discriminator based on pattern matching or machine learning by using an image, the feature amount of the image as data showing the feature may be stored in the dangerous act dictionary data D2.

Warning data depends on the type of the dangerous act. The warning data may be voice data in which a predetermined voice is recorded in advance. In addition, the warning data may be an image or text data showing a warning to be displayed on the display. In addition, the warning data may be light such as a warning light. Incidentally, in the example shown in FIG. 5, the warning data varies depending on the type of the dangerous act but is not limited thereto. In other embodiments, the warning data may be common warning data. For example, “Please do not do dangerous acts”, “Please follow the safety rules”, an icon indicating caution, an icon indicating danger, blinking display on the screen, or the like, that is, anything that calls caution in common regardless of the type of the dangerous act may be used.

Incidentally, the types of dangerous acts, the feature data, and the additional condition stored in the dangerous act dictionary data D2 may differ depending at the site. For example, when walking while operating the smartphone is prohibited at one site and the act of stopping to operate the smartphone is not prohibited, the operation of the smartphone itself may be prohibited at another site. The dangerous act may be stipulated as rules at the site.

The processor 210 includes an acquisition unit 211, an extraction unit 212, a dangerous act determination unit 213, a warning unit 214, a recording unit 215, and a transmission unit 216 by executing a program.

The acquisition unit 211 acquires captured images from the plurality of cameras 121.

The extraction unit 212 extracts a partial image in which the person is reflected from the captured image acquired by the acquisition unit 211 based on the human dictionary data D1. Exemplary examples of a detection method of a person include pattern matching, object detection processing based on machine learning, or the like.

Incidentally, in the first embodiment, the extraction unit 212 extracts a person by using the feature amount of the image, but is not limited thereto. For example, in another embodiment, the extraction unit 212 may extract a person based on a measured value of light detection and ranging (LiDAR) or the like.

The dangerous act determination unit 213 determines whether the person extracted by the extraction unit 212 performs a dangerous act based on the dangerous act dictionary data D2 that is the captured data and the partial image extracted by the extraction unit 212. When determination is made that a person performs in a dangerous act, the dangerous act determination unit 213 specifies the type of the dangerous act.

The warning unit 214 outputs a warning voice from the speaker 122 when the dangerous act determination unit 213 determines that the person performs a dangerous act.

When determination is made that a person performs a dangerous act by the dangerous act determination unit 213, the recording unit 215 stores the dangerous act history data associated with the captured image, the imaging time, the imaging position, and the type of the dangerous act acquired by the acquisition unit 211 in the storage 250. Incidentally, the dangerous act history data does not necessarily have to be associated with all of the captured images, the imaging time, the imaging position, and the type of the dangerous act, and may include the captured image associated with at least one of the data related to the imaging time, the imaging position, the type of the dangerous act, and other dangerous acts. In addition, at least one of the data related to the imaging time, the imaging position, the type of the dangerous act, and other dangerous acts may be stored. In addition, the number of dangerous acts may be stored, and for example, the number of dangerous acts may be stored for each type of the dangerous act.

The transmission unit 216 transmits the dangerous act history data stored in the recording unit 215 to a server device (not shown). In addition, the transmission unit 216 does not necessarily have to transmit all of the captured images, the imaging time, the imaging position, and the type of the dangerous act, and may transmit a portion of the dangerous act history data. For example, information indicating the number of dangerous acts or the number of times for each type of dangerous act may be transmitted.

<<Detection Method of Dangerous Acts>>

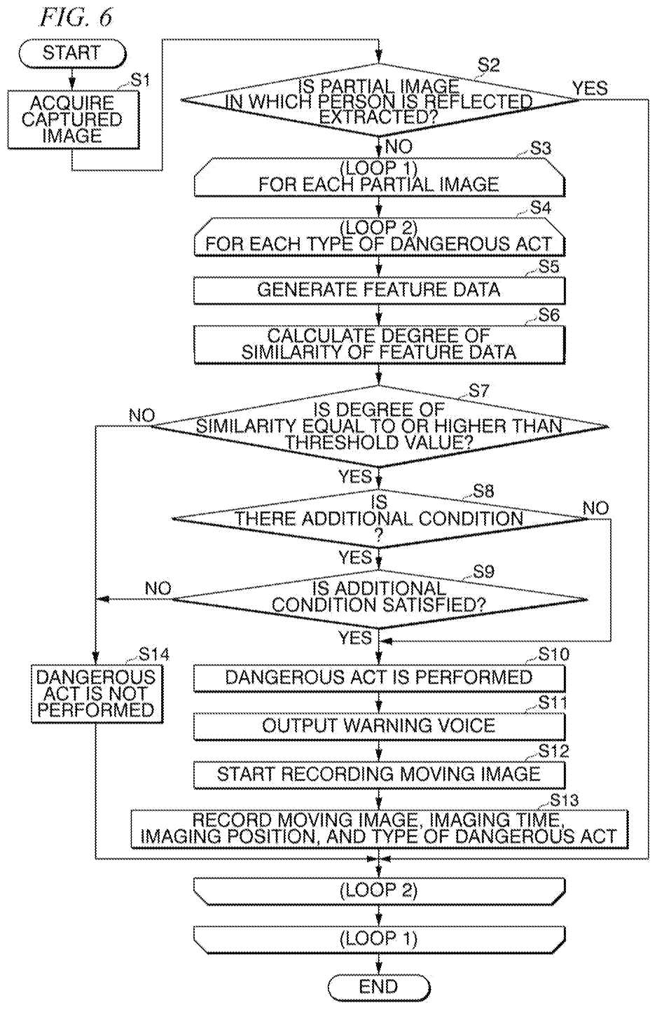

FIG. 6 is a flowchart representing an operation of the control device 143 according to the first embodiment.

When the control device 143 starts periphery monitoring processing, the processing shown in FIG. 6 is repeatedly executed.

The acquisition unit 211 acquires captured images from the plurality of cameras 121 (step S1). Next, the extraction unit 212 executes extraction processing of a partial image in which a person is reflected by using the human dictionary data D1 for each captured image acquired in the step S1 and determines whether one or more partial images have been extracted (step S2). When the partial image in which a person is reflected is not extracted (step S2: NO), the control device 143 ends the processing because a person who performs a dangerous act is not present.

When the partial image in which a person is reflected is extracted (step S2: YES), the dangerous act determination unit 213 selects one or more partial images extracted in the step S2 one by one, and executes processing of a step S4 to a step S14 below (step S3).

The dangerous act determination unit 213 selects the type of the dangerous act stored in the dangerous act dictionary data D2 one by one and executes the processing of the step S5 to the step S14 below (step S4).

The dangerous act determination unit 213 specifies the feature data associated with the type selected in the step S4, and generates the same type of feature data from the partial image selected in the step S3 (step S5). The dangerous act determination unit 213 calculates the degree of similarity between the feature data associated with the type selected in the step S4 and the feature data of the partial image generated in the step S5 (step S6). The dangerous act determination unit 213 determines whether the degree of similarity of the feature data is equal to or higher than a predetermined threshold value (step S7).

The dangerous act determination unit 213 determines whether the degree of similarity of the feature data is equal to or higher than a predetermined threshold value (step S7). When the degree of similarity of the feature data is equal to or higher than the threshold value (step S7: YES), the dangerous act determination unit 213 determines whether there is an additional condition associated with the feature data (step S8). When there is an additional condition (step S8: YES), the dangerous act determination unit 213 determines whether the partial image selected in the step S3 satisfies the additional condition (step S9). Incidentally, when the additional condition is a condition related to speed, the dangerous act determination unit 213 determines, for example, whether the distance between the position of the partial image extracted in the previous captured image and the position of the partial image selected in the step S3 is equal to or higher than a predetermined distance.

When the additional condition is satisfied (step S9: YES), or when there is no additional condition in the matching feature data (step S8: NO), the dangerous act determination unit 213 determines that the person related to the partial image selected in the step S3 performs the dangerous act of the type selected in the step S4 (step S10). The warning unit 214 outputs a warning voice from the speaker 122 based on the warning data associated with the type of the dangerous act selected in the step S4 (step S11).

The recording unit 215 starts recording a moving image (step S12). That is, the recording unit 215 generates a moving image by recording the captured image of the camera 121 for a certain period of time after determining that the dangerous act is performed in the step S10. In the moving image, a person who performs a dangerous act is reflected. Then, the storage 250 stores the moving image generated in the step S11, the imaging time, the imaging position, and the dangerous act history data associated with the type of the dangerous act specified in the step S10 (step S13). Incidentally, the dangerous act history data recorded in the storage 250 is later transmitted to the server device by the transmission unit 216. Incidentally, the imaging position is represented by, for example, position data acquired by a GNSS positioning device (not shown) of the work machine 100 at the time of capturing an image.

On the other hand, when the additional condition is not satisfied (step S9: NO), or when the degree of similarity of the feature data is less than the threshold value (step S7: NO), the dangerous act determination unit 213 determines that the person related to the partial image selected in the step S3 does not perform the type of the dangerous act selected in the step S4 (step S14).

Incidentally, the processing shown in FIG. 6 is only an example, and in another embodiment, the control device 143 may perform processing different from that shown in FIG. 6. For example, the dangerous act dictionary data D2 according to another embodiment may not have an additional condition. In this case, the control device 143 may not have to perform the determination of the steps S8 and S9. In addition, in another embodiment, the control device 143 may not perform at least one of the output of the warning voice in the step S11 and the recording of the moving image in the step S13. In addition, in other embodiments, the warning may not have to be one based on voice, such as displaying on the display 143D or emitting a warning light. In addition, the loop processing of at least one of the step S3 and the step S4 may be realized by parallel processing.

<<Effects>>

In this manner, the control device 143 can determine the dangerous act when the person reflected in the captured image performs the dangerous act. As a result, the control device 143 can reduce the burden on the supervisor to pay attention to the dangerous act at the site. In addition, the control device 143 can output a warning when the control device 143 determines the dangerous act. For example, the warning voice can be output toward the outside of the work machine 100. As a result, the worker who performs the dangerous act in the vicinity of the work machine 100 can be aware of his or her own dangerous act and can alert also other workers to the dangerous act. For example, the warning image can be displayed on the display 143D. As a result, the operator of the work machine 100 can be alerted.

In addition, the control device 143 can record the data related to the dangerous act in the storage 250. For example, a moving image reflecting a scene of a dangerous act can be recorded in the storage 250. As a result, the scene in which there has been the dangerous act can be stored. In addition, the control device 143 can transmit data related to the dangerous act to the server device. For example, the moving image reflecting a scene of the dangerous act can be transmitted to the server device. As a result, the supervisor at the site can later confirm whether the dangerous act is actually present by confirming the moving image.

### Operation Example

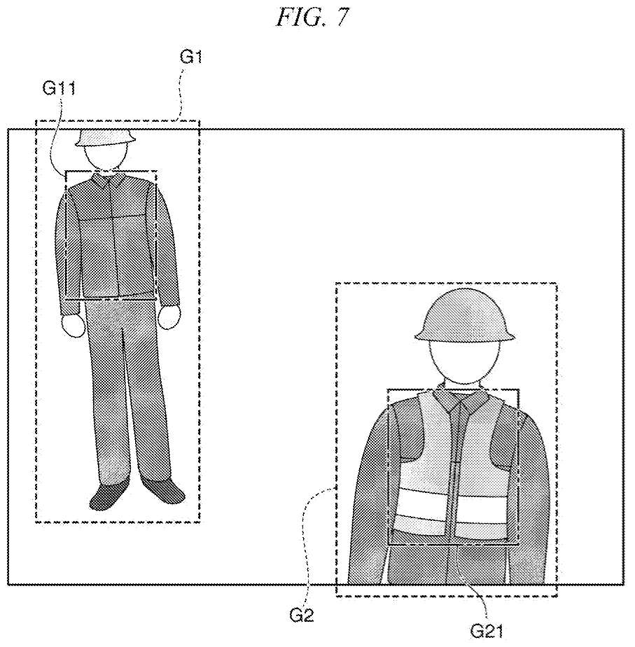

FIG. 7 is a diagram representing an example of a captured image by the camera 121 according to the first embodiment.

When the camera 121 obtains a captured image as shown in FIG. 6, the extraction unit 212 of the control device 143 extracts two partial images G1 and G2 in the step S2. First, the dangerous act determination unit 213 executes the processing of the step S5 to the step S14 for each type of the dangerous act with respect to the partial image G1. At this time, the dangerous act determination unit 213 compares the feature data related to “non-wearing of the safety vest” with the feature data of a body portion Gil of the partial image G1 in the step S5 to the step S7 and determines that the degree of similarity is high. Since the additional condition is not associated with the feature data related to “non-wearing of the safety vest”, the dangerous act determination unit 213 determines in the step S10 that the person related to the partial image G1 performs a dangerous act. Therefore, the warning unit 214 outputs a warning voice saying “Please wear a safety vest” from the speaker 122. In addition, the recording unit 215 records a moving image including the image shown in FIG. 6 in the storage 250.

In addition, the dangerous act determination unit 213 executes the processing of the step S5 to the step S14 for each type of the dangerous act with respect to the partial image G2. The dangerous act determination unit 213 compares the feature data related to “non-wearing of the safety vest” with the feature data of a body portion G21 of the partial image G1 and determines that the degree of similarity is low. Similarly, the processing of the step S5 to the step S14 is executed for other types of dangerous acts, and since the degree of similarity is low in any of the dangerous acts and the additional condition is not satisfied, the dangerous act determination unit 213 determines that the person related to the partial image G2 does not perform the dangerous act in the step S14.

### OTHER EMBODIMENTS

The embodiments have been described above in detail with reference to the drawings; however, the specific configurations are not limited to the above-described configurations, and various design changes or the like can be made. Namely, in another embodiment, the order of the above-described processes may be appropriately changed. In addition, some of the processes may be executed in parallel.

In the embodiment described above, the work machine 100 includes the plurality of cameras 121 and the speakers 122, but is not limited thereto. For example, in other embodiments, the camera or the speaker may be provided outside the work machine 100. Exemplary examples of the speaker and the camera provided to the outside include a speaker and a camera installed at the site, a speaker and a camera provided in another work machine 100, or the like.

The detection system according to the above-described embodiment may be provided outside the work machine 100.

In addition, in another embodiment, a portion of the configurations constituting the detection system may be mounted inside the work machine 100, and other configurations may be provided outside the work machine 100. For example, a detection system may be configured such that the display 143D is provided in a remote operation room provided remotely from the work machine 100. In addition, in another embodiment, the plurality of computers described above or a single computer described above may all be provided outside the work machine 100. For example, the detection system may include a combination of a fixed point camera installed at the site and one or a plurality of computers provided in a control room or the like in place of the control device 143 or in addition to the control device 143. In this case, the computer provided outside the work machine 100 has the same configuration as a portion or the entire portion of the control device 143 shown in FIG. 4. A computer provided outside the work machine 100 may perform the processing shown in FIG. 6 based on the captured image obtained from the fixed point camera.

In addition, the detection system according to the above-described embodiment outputs a warning voice from the speaker 122 of the work machine 100 and alerts a worker or a supervisor who performs a dangerous act in the vicinity of the work machine 100. The present invention is not limited thereto. For example, the detection system of another embodiment may be provided with a speaker inside the cab 140 and alert the operator. Incidentally, the speaker may be provided as a buzzer provided in the cab or an integrated speaker provided in the display 143D in the cab, and the speaker may be used to alert the operator.

In addition, the detection system according to the above-described embodiment outputs a warning voice from the speaker 122 of the work machine 100 but is not limited thereto. For example, the detection system of another embodiment may output a warning voice to a fixed speaker provided at the site. In addition, according to yet another embodiment, the detection system of the work machine 100 may output a warning voice to the speaker 122 of the other work machine 100 by vehicle-to-vehicle communication.

In addition, in the above-described embodiment, an example of determining a person who performs a dangerous act outside the work machine 100 has been described but is not limited thereto. For example, in another embodiment, the dangerous act of a person in the work machine 100 may be determined. For example, a camera may be provided inside the cab 140 so that an image of the operator can be captured, and the detection system may determine the dangerous act of the operator. In this case, an alert can be made by outputting a warning voice from a speaker provided in the cab or displaying an image or a text indicating a warning on the display 143D.

In addition, the detection system according to the above-described embodiment determines, after extracting a person, the presence or absence of a dangerous act for the person but is not limited thereto. For example, in another embodiment, the presence or absence of the person who performs the dangerous act may be estimated directly from the captured image by using a learned model that estimates the presence or absence of a person who performs a dangerous act from the entire captured image.

In addition, the detection system according to the above-described embodiment records a moving image reflecting a scene of a dangerous act in the step S12 described above, but is not limited thereto. For example, the detection system according to another embodiment may record the captured image acquired in the step S1, that is, the still image.

In addition, the detection system according to the above-described embodiment outputs a warning voice according to the type of the dangerous act, but is not limited thereto. For example, the detection system according to another embodiment may output a horn sound regardless of the type of the dangerous act.

In addition, in another embodiment, the detection system may calculate the degree of danger of a person who performs a dangerous act and determine whether to output the warning based on the degree of danger. For example, the degree of danger may be calculated based on the distance from the person who performs the dangerous act to the swing center of the work equipment 130, and a warning may be output when the degree of danger exceeds the threshold value.

In addition, in another embodiment, the detection system (detection system) may be configured to include only the display 143D among the display 143D and the speaker 122. In this case, the operator of the work equipment 130 and the supervisor at the site can alert based on the image or the text indicating the warning displayed on the display 143D.

In addition, the work machine 100 according to the above-described embodiment is a hydraulic excavator, but is not limited thereto. For example, the work machine 100 according to another embodiment may be another work machine such as a dump truck, a bulldozer, or a wheel loader.

### INDUSTRIAL APPLICABILITY

According to the above aspect, the presence or absence of the dangerous act can be easily detected by using the detection system.

### REFERENCE SIGNS LIST

100: Work machine
110: Undercarriage
120: Swing body
121: Camera
130: Work equipment
143: Control device
211: Acquisition unit
212: Extraction unit
213: Dangerous act determination unit
214: Warning unit
215: Recording unit
216: Transmission unit

1. A detection system comprising:
an acquisition unit configured to acquire captured data from an imaging device that captures an image of a site; and
a dangerous act determination unit configured to determine whether a person who performs a dangerous act is present at the site based on the captured data.

2. The detection system according to claim 1, further comprising:
an extraction unit configured to extract a portion corresponding to the person from the captured data,
wherein the dangerous act determination unit determines whether the person reflected in the extracted portion performs the dangerous act.

3. The detection system according to claim 1, further comprising:
a warning unit configured to output a warning when determination is made that the person who performs the dangerous act is present.

4. The detection system according to claim 3, wherein the warning unit outputs a voice corresponding to a type of the dangerous act as the warning.

5. The detection system according to claim 1, further comprising:
a recording unit configured to, when determination is made that the person who performs the dangerous act is present, record the captured data related to the determination.

6. The detection system according to claim 5, wherein the recording unit records data related to the dangerous act in association with the captured data.

7. The detection system according to claim 1, wherein the dangerous act includes non-wearing of protective equipment.

8. A detection method comprising:
a step of acquiring captured data from an imaging device that captures an image of a site by a detection system; and
a step of determining whether a person who performs a dangerous act is present at the site based on the captured data by the detection system.

9. A detection system comprising:
an acquisition unit configured to acquire captured data from an imaging device that captures an image of a site at which a work machine operates; and
a dangerous act determination unit configured to determine whether a person who performs a dangerous act is present at the site based on the captured data.
